(19) United States
(12) Patent Application Publication
(10) Pub. No.: US 2024/0076429 A1
(43) Pub. Date: Mar. 7, 2024

(54) CONDUCTIVE FLUORINATED ELASTOMERIC MATERIALS AND METHODS OF USE

(71) Applicant: Meta Platforms Technologies, LLC, Menlo Park, CA (US)

(72) Inventors: Wenyang Pan, Redmond, WA (US); Shawn Reese, Renton, WA (US); Li Yao, Bothell, WA (US); Ziyan Liu, Renton, WA (US); Fang He, Bothell, WA (US); Robert Cole Bolger-Cruz, Riverside, CA (US); Sandeep Rekhi, San Jose, CA (US)

(21) Appl. No.: 18/460,204

(22) Filed: Sep. 1, 2023

Related U.S. Application Data
(60) Provisional application No. 63/374,476, filed on Sep. 2, 2022.

(51) Int. Cl. C08F 214/28; C08F 2/04; C08K 3/04; C08L 27/20

(52) U.S. Cl. CPC C08F 214/282; C08F 2/04; C08K 3/041; C08K 3/046; C08L 27/20; C08K 2201/003; C08L 2203/20; C08L 2207/04

(57) ABSTRACT

Described herein are conductive fluorinated elastomeric materials and methods of making and using the same. The conductive fluorinated elastomeric materials include a fluorinated polymeric matrix and one or more high aspect-ratio fillers, wherein a surface resistance of the elastomeric material is 15 ohm/square or less and/or a bulk conductivity of the elastomeric material is 0.7 Ohm-cm or less. Also described herein are liquid fluorinated elastomeric compositions, including a fluorinated polymer, one or more high aspect-ratio fillers, and a solvent. Further described herein are molded products including the conductive fluorinated elastomeric materials as described herein and wearable devices including the molded products.

### CROSS-REFERENCE TO PRIORITY APPLICATION

This application claims the benefit of and priority to U.S. Provisional Patent Application No. 63/374,476, filed Sep. 2, 2022, the contents of which are incorporated herein by reference in its entirety.

### BACKGROUND

Conductive elastomers have been used for developing soft electrodes, soft actuators, and soft sensors. Such elastomers are particularly important for biopotential electrodes, which convert motoneuron signals into electrical signals. The electrical signals are then processed and amplified for external device control. To maximize the performance of the biopotential electrodes, high conductivity is required, as well as good compatibility with the human body. However, to increase the conductivity, high volumes of conductive filler loading are usually needed. Such high levels of filler decrease the softness and compressibility of the elastomer, resulting in discomfort for the user and a reduced elastomer reliability. In addition, elastomers used to date suffer from a lack of durability with usage over time.

### SUMMARY

Described herein are conductive fluorinated elastomeric materials and methods of making and using the same. A conductive fluorinated elastomeric material as described herein comprises a fluorinated polymeric matrix and one or more high aspect-ratio fillers, wherein a surface resistance of the elastomeric material is 15 ohm/square or less and/or a bulk conductivity of the elastomeric material is 0.7 Ohm-cm or less. The fluorinated polymeric matrix can comprise a fluoroelastomer (e.g., an FKM rubber) or a fluorosilicone.

Optionally, the one or more high aspect ratio-fillers comprises a one-dimensional (1D) filler, a two-dimensional (2D) filler, or a combination thereof. The one or more high aspect-ratio fillers for use in the conductive fluorinated elastomeric materials can optionally comprise an inorganic filler. Optionally, the one or more high aspect-ratio fillers comprises a conductive filler, such as a carbon-based filler. The carbon-based filler can comprise carbon nanotubes, carbon nanofibers, or combinations thereof. In some cases, a surface of the carbon-based filler is functionalized. Optionally, the surface of the carbon-based filler is functionalized with a hydroxyl group, a carboxylic group, a thiol group, or an amino group.

In some cases, the carbon-based filler comprises carbon nanotubes having a diameter from 1 nm to 100 nm (e.g., from 2 nm to 90 nm, from 5 nm to 50 nm, or from 8 nm to 15 nm). Optionally, the carbon-based filler comprises carbon nanofibers having a diameter from 100 nm to 1000 nm (e.g., from 100 nm to 500 nm or from 130 nm to 200 nm). Optionally, the carbon-based filler comprises a combination of carbon nanotubes and carbon nanofibers. A weight ratio of the carbon nanotubes to the carbon nanofibers can be selected to provide synergistic conductive effects to the materials described herein. In some cases, a weight ratio of the carbon nanotubes to the carbon nanofibers is from 1:0.2 to 1:3, from 1:0.5 to 1:2.5, or from 1:1 to 1:2.

Optionally, the high-aspect ratio filler is present in an amount of 0.5 wt. % to 30 wt. % based on the weight of the conductive fluorinated elastomeric material. For example, the high-aspect ratio filler can be present in an amount of 2 wt. % to 15 wt. % based on the weight of the conductive fluorinated elastomeric material.

The conductive fluorinated elastomeric materials described herein can optionally comprise one or more additional additives. Optionally, the one or more additional additives is selected from the group consisting of foaming agents, blowing agents, dispersants, plasticizers, surfactants, thixotropic agents, and diluents.

Also described herein are liquid fluorinated elastomeric compositions. A liquid fluorinated elastomeric composition as described herein comprises a fluorinated polymer, one or more high aspect-ratio fillers in an amount of 0.5 wt. % to 30 wt. %, and a solvent. Optionally, the liquid fluorinated elastomeric composition further comprises a crosslinker.

In some cases, the crosslinker in the liquid fluorinated elastomeric composition comprises a peroxide-activated crosslinker or a heat-activated crosslinker. Optionally, the crosslinker comprises a triazine. In some cases, the crosslinker comprises a cyanurate or an isocyanurate. For example, the crosslinker can be selected from the group consisting of triallyl cyanurate, triallyl isocyanurate, trimethylallyl cyanurate, trimethylallyl isocyanurate, trihexenyl cyanurate, trihexenyl isocyanurate, triallylphenyl cyanurate, and triallylphenyl isocyanurate. The liquid fluorinated elastomeric compositing can further comprise a foaming agent or a blowing agent.

Additionally described herein are methods of making a conductive fluorinated elastomeric material. A method of making a conductive fluorinated elastomeric material as described herein comprises mixing a fluorinated polymeric matrix and one or more high aspect-ratio fillers in the presence of a crosslinker and a solvent to form a composite, wherein the mixing is performed using solvent-assisted compounding. Optionally, the solvent comprises an organic solvent. The method can further include the step of removing the solvent, which can optionally be performed at a temperature of at least 60° C. Optionally, the method includes a step of molding the composite at a temperature from 30° C. to 100° C. The method can further comprise curing the composite. The step of curing the composite can be performed at a temperature of 130° C. to 200° C. Optionally, the step of curing the composite can be performed for a period of from 30 seconds to 5 hours.

Further described herein is a molded product, comprising a conductive fluorinated elastomeric material as described herein. In some cases, the molded product comprises an electrode (e.g., a biopotential electrode). The molded product as described herein can have a surface resistance of from 1.5 ohm/square to 15 ohm/square (e.g., from 2 ohm/square to 12 ohm/square). The molded product as described herein can exhibit a bulk conductivity of 0.7 Ohm-cm or lower (e.g., 0.5 Ohm-cm or less). Optionally, the hardness of the molded product is 95 Shore A or lower. The tensile strength of the molded product can be 5 MPa or greater and/or the modulus of the molded product can be 30 MPa or lower. Optionally, the skin contact impedance of the molded product on the skin of a subject is 1 MOhms or lower.

Further described herein is a wearable device comprising a molded product as described herein integrated into the device. Optionally, the wearable device can be a wristband or a monolithic conductive band. The wearable device can collect biopotential signals and/or electromyography signals.

The details of one or more embodiments are set forth in the drawings and the description below. Other features, objects, and advantages will be apparent from the description and drawings, and from the claims.

### BRIEF DESCRIPTION OF THE DRAWINGS

FIG. 1 is a graph showing the tensile strength of a fluoroelastomer before curing and after curing.

FIG. 2 is a graph showing the average skin impedance on a subject's wrist for both gold and fluoroelastomer electrodes as described herein.

### DETAILED DESCRIPTION

Described herein are novel conductive fluorinated elastomeric materials, including a fluorinated polymeric matrix loaded with one or more high aspect-ratio fillers in an appropriate amount to achieve the desired conductivity, excellent flexibility and stretchability, and a desirably smooth finish.

The fluorinated polymeric matrix of the materials described herein include one or more fluorocarbon groups in the backbone or side chains of the synthetic polymers. Such fluorinated polymeric matrices include, for example, fluoroelastomers (e.g., FKM) and fluorosilicone rubbers. In comparison to silicone rubbers (which are also used for preparing elastomeric materials in the industry), fluorinated polymeric matrices as described herein are tougher, more tear resistant, and have an increased comfortability on the skin for wearers. In addition, fluorinated polymeric matrices are more resistant to oxygen, ozone, solvents, heats, and oils, which can result in the deterioration of silicone rubbers. With these benefits, however, come obstacles associated with preparing composites. Specifically, commercially used fluorinated polymeric matrices are generally more viscous and require higher curing temperatures and post-processing temperatures. Such properties make the compounding the fillers in fluorinated polymeric matrices difficult, if not impossible; as such, fluorinated polymeric matrix-containing composites are few, and none possess levels of high electric conductivity needed with certain applications.

The materials described herein, however, are prepared from such fluorinated polymeric matrices (and thus include the beneficial durability and comfortability properties described above) along with specially designed fillers that allow the materials to achieve the desired electrical conductivity. The materials achieve, for example, a surface resistance of 15 ohm/square or less and/or a bulk conductivity of 0.7 Ohm-cm or less.

While previously impossible to prepare, the disclosure herein describes a solvent-assisted compounding method for mixing conductive fillers into the fluorinated polymeric matrices. The solution resulting from the compounding method is less viscous and creates an environment to better disperse the fillers in the matrix. Beneficially, the resulting composites (including the high aspect-ratio fillers in the matrix) remain moldable at a relatively low temperature (e.g., temperatures as low as 70° C.), while being cured at relatively high temperatures (e.g., temperatures greater than 150° C.).

The fluorinated elastomeric materials described herein have been successfully processed and shaped into materials such as soft electrodes (e.g., biopotential electrodes, including electromyography (EMG) electrodes, electrocardiogram (ECG) electrodes, electroencephalogram (EEG) electrodes, and the like) and additionally placed within wearable devices to effectively capture and collect signals. Notably, the soft electrodes prepared from the conductive fluorinated elastomeric materials described herein perform similarly to, or more effectively than, gold coated metal electrodes typically used in biopotential devices.

### Fluorinated Polymeric Matrix

As noted above, the conductive fluorinated elastomeric materials described herein include a fluorinated polymeric matrix. The fluorinated polymeric matrix can be characterized as synthetic polymers having fluorocarbon groups in the backbone or sidechains of the polymer. The fluorinated polymeric matrix optionally can be a fluoroelastomer, such as an FKM rubber. Optionally, the fluorinated polymeric matrix be a fluorosilicone. Suitable fluorinated polymeric matrices for inclusion in the materials described herein include, for example, the VITON fluoroelastomers, commercially available from Chemours (Wilmington, DE), and the TECNOFLON fluoroelastomers, commercially available from Solvay (Brussels, Belgium).

In some examples, the fluorinated polymeric matrix for use in the materials described herein can include polymers including one or more of vinylidene fluoride (VF₂), hexafluoropropylene (HFP), tetrafluoroethylene (TFE), and/or perfluoromethylvinylether (PMVE). For example, the fluorinated polymeric matrix can include a dipolymer of VF₂. In other examples, the fluorinated polymeric matrix can include a terpolymer of VF2, HFP, and TFE. In still other examples, the fluorinated polymeric matrix can include a copolymer of TFE and propylene. In further examples, the fluorinated polymeric matrix can include a copolymer of ethylene, TFE, and PMVE. Any suitable fluorinated polymeric matrix can be used, based on the properties of the polymers, to achieve the desired final properties of the resulting product. For example, the desired chemical resistance, surface finishing, toughness, and/or flexibility can be considered when selecting the appropriate fluorinated polymeric matrix for use in the materials described herein.

Other fluorinated polymers, as known in the art, can also be used as the fluorinated polymeric matrix in the materials described herein.

### High Aspect-Ratio Fillers

The conductive fluorinated elastomeric materials described herein also include one or more high aspect-ratio fillers, such as one dimensional (1D) fillers and/or two-dimensional (2D) fillers. In some cases, the high aspect-ratio includes a 1D filler. Optionally, the high aspect-ratio filler can include an inorganic filler and can be a conductive filler. Optionally, the high aspect-ratio filler can be a carbon-based filler, such as one or more of carbon nanotubes or carbon nanofibers or combinations of these. One or more surfaces of the filler can be functionalized with a functional group, such as a hydroxyl group (—OH), a carboxylic group (—C(O)O—), a thiol group (—SH), or an amino group (—NH₂).

The aforementioned functional groups can optionally be substituted with one or more groups. As used herein, the term substituted includes the addition of an alkoxy, aryloxy, amino, alkyl, alkenyl, alkynyl, aryl, heteroalkyl, heteroalkenyl, heteroalkynyl, heteroaryl, cycloalkyl, or heterocycloalkyl group to a position attached to the main chain of the alkoxy, aryloxy, amino, alkyl, alkenyl, alkynyl, aryl, heteroalkyl, heteroalkenyl, heteroalkynyl, heteroaryl, cycloalkyl, or heterocycloalkyl, e.g., the replacement of a hydrogen by one of these molecules. Examples of substitution groups include, but are not limited to, hydroxy, halogen (e.g., F, Br, Cl, or I), and carboxyl groups. Conversely, as used herein, the term unsubstituted indicates the alkoxy, aryloxy, amino, alkyl, alkenyl, alkynyl, aryl, heteroalkyl, heteroalkenyl, heteroalkynyl, heteroaryl, cycloalkyl, or heterocycloalkyl has a full complement of hydrogens, i.e., commensurate with its saturation level, with no substitutions, e.g., linear decane (—(CH₂)₉—CH₃).

The carbon-based fillers for use in the conductive fluorinated elastomeric materials can have an appropriate size for the desired use. In some cases, carbon nanotubes for use as the carbon-based fillers can have a diameter from 1 nm to 100 nm (e.g., from 2 nm to 90 nm, from 5 nm to 50 nm, or from 8 nm to 15 nm). The diameter of the carbon nanotubes can be, for example 1 nm, 2 nm, 3 nm, 4 nm, 5 nm, 6 nm, 7 nm, 8 nm, 9 nm, 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, or 100 nm.

Optionally, at least 50% of the carbon nanotubes for use as the carbon-based fillers have a diameter in the indicated range (e.g., from 1 nm to 100 nm, from 2 nm to 90 nm, from 5 nm to 50 nm, or from 8 nm to 15 nm). In some cases, at least 60%, at least 65%, at least 70%, at least 75%, at least 80%, at least 85%, at least 90%, or at least 95% of the carbon nanotubes present as carbon-based fillers in the materials have a diameter in the indicated range (e.g., from 1 nm to 100 nm, from 2 nm to 90 nm, from 5 nm to 50 nm, or from 8 nm to 15 nm).

In some cases, the amount of carbon nanotubes for use as the carbon-based fillers can be from 2.5 wt. % to 30 wt. % (e.g., 5 wt. % to 20 wt. % or 5 wt. % to 15 wt. %) based on the weight of the conductive fluorinated elastomeric material. For example, the amount of carbon nanotubes in the elastomeric material can be 2.5 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %, 21 wt. %, 22 wt. %, 23 wt. %, 24 wt. %, 25 wt. %, 26 wt. %, 27 wt. %, 28 wt. %, 29 wt. %, or 30 wt. %.

In some cases, the carbon nanofibers for use as the carbon-based fillers can have a diameter from 100 nm to 1000 nm (e.g., from 100 nm to 500 nm or from 130 nm to 200 nm). The diameter of the carbon nanofibers can be, for example 100 nm, 110 nm, 120 nm, 130 nm, 140 nm, 150 nm, 160 nm, 170 nm, 180 nm, 190 nm, 200 nm, 300 nm, 400 nm, 500 nm, 600 nm, 700 nm, 800 nm, 900 nm, or 1000 nm.

Optionally, at least 50% of the carbon nanofibers for use as the carbon-based fillers have a diameter in the indicated range (e.g., from 100 nm to 500 nm or from 130 nm to 200 nm). In some cases, at least 60%, at least 65%, at least 70%, at least 75%, at least 80%, at least 85%, at least 90%, or at least 95% of the carbon nanofibers present as carbon-based fillers in the materials have a diameter in the indicated range (e.g., from 100 nm to 500 nm or from 130 nm to 200 nm).

In some cases, the amount of carbon nanofibers for use as the carbon-based fillers can be from 2.5 wt. % to 30 wt. % (e.g., 5 wt. % to 20 wt. % or 5 wt. % to 15 wt. %) based on the weight of the conductive fluorinated elastomeric material. For example, the amount of carbon nanofibers in the elastomeric material can be 2.5 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %, 21 wt. %, 22 wt. %, 23 wt. %, 24 wt. %, 25 wt. %, 26 wt. %, 27 wt. %, 28 wt. %, 29 wt. %, or 30 wt. %.

In some cases, the carbon-based filler comprises a combination of carbon nanotubes and carbon nanofibers. As described herein and demonstrated in the examples, the combination of carbon nanotubes and carbon nanofibers in the appropriate amounts can synergistically impact the performance of the elastomeric materials (e.g., by desirably lowering the skin-electrode contact impedance of the materials). By way of example, a weight ratio of the carbon nanotubes to the carbon nanofibers can from 1:0.1 to 1:5 (e.g., from 1:0.2 to 1:3, from 1:0.5 to 1:2.5, or from 1:1 to 1:2). In some cases, the weight ratio of the carbon nanotubes to the carbon nanofibers for inclusion in the elastomeric materials can be 1:0.1, 1:0.2, 1:0.3, 1:0.4, 1:0.5, 1:0.6, 1:0.7, 1:0.8, 1:0.9, 1:1, 1:1.1, 1:1.2, 1:1.3, 1:1.4, 1:1.5, 1:1.6, 1:1.7, 1:1.8, 1:1.9, 1:2, 1:2.5, 1:3, 1:3.5, 1:4, 1:4.5, or 1:5.

In some cases, the total amount of high aspect-ratio filler present in the conductive fluorinated elastomeric materials can be 50 wt. % or less (e.g., from 0.1 wt. % to 50 wt. %, from 0.5 wt. % to 35 wt. %, from 0.5 wt. % to 20 wt. %, or from 2 wt. % to 15 wt. %) based on the weight of the conductive fluorinated elastomeric material. For example, the total amount of high aspect-ratio filler present (e.g., the combined amount of all high aspect-ratio filler types, including, for example, the carbon nanotubes and the carbon nanofibers) can be 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt., %, 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %, 21 wt. %, 22 wt. %, 23 wt. %, 24 wt. %, 25 wt. %, 26 wt. %, 27 wt. %, 28 wt. %, 29 wt. %, 30 wt. %, 31 wt. %, 32 wt. %, 33 wt. %, 34 wt. %, 35 wt. %, 36 wt. %, 37 wt. %, 38 wt. %, 39 wt. %, 40 wt. %, 41 wt. %, 42 wt. %, 43 wt. %, 44 wt. %, 45 wt. %, 46 wt. %, 47 wt. %, 48 wt. %, 49 wt. %, or 50 wt. %.

### Additional Additives

The conductive fluorinated elastomeric materials described herein can optionally include one or more additional additives. Suitable additives for inclusion in the materials described herein can be, for example, one or more of dispersants, plasticizers, surfactants, thixotropic agents, and diluents. Additional additives for use in the materials describe herein can include hardeners, accelerators (e.g., peroxide accelerators), thickeners, humectants, desiccants, fire retardants, electrical insulators, vibration dampeners, thermal insulators, corrosion inhibitors, antioxidants, pigments, dyes, magnetic particles, thermochromic agents (i.e., compounds that can change color with changing temperature), mechanochromic agents (i.e., compounds that can change color under mechanical deformation), anti-glare agents, anti-reflective agents, infrared reflective agents, stealth agents, textural agents, fragrances, self-cleaning agents, hydrophobic agents, hydrophilic agents, or any combination thereof.

In some cases, the conductive fluorinated elastomeric materials can include foaming agents or blowing agents. The foaming agents and blowing agents can be effectively incorporated into the materials described herein to result in conductive composites with increased porosity and/or lower hardness.

The additional additives can be present in the materials described herein in an amount of 10 wt. % or less based on the weight of the conductive fluorinated elastomeric material. For example, one or more additional additives can be included in an amount of 0.01 wt. % to 10 wt. %, 0.1 wt. % to 8 wt. %, 0.5 wt. % to 5 wt. %, or 1 wt. % to 3 wt. % based on the weight of the conductive fluorinated elastomeric material. In some cases, for example for certain diluents and softeners (e.g., silicone oil and mineral oil), the content of the additive can be up to 30 wt. % (e.g., from 1 wt. % to 30 wt. %, from 5 wt. % to 25 wt. %, or from 10 wt. % to 20 wt. %).

### Methods of Making and Resulting Products

Also described herein are methods of producing the conductive fluorinated elastomeric materials described above. The methods for producing the conductive fluorinated elastomeric materials as described herein can include a step of mixing a fluorinated polymeric matrix and one or more high aspect-ratio (e.g., one-dimensional (1D)) fillers in the requisite amounts as detailed above, followed by further processing steps (e.g., molding), and curing. The mixing, processing, and subsequent steps can be tailored to suit the selected fluorinated polymeric matrix. For example, the conductive fluorinated elastomeric materials as described herein can be prepared by solvent-assisted compounding, molded at an elevated temperature (e.g., 30° C. to 100° C.), and cured at a temperature of 130° C. to 200° C. for 30 seconds to 5 hours, as further detailed below.

As described above, the conductive fluorinated elastomeric materials as described herein can be prepared by solvent-assisted compounding. In some cases, the fluorinated polymer can be combined with a solvent to form a liquid fluorinated elastomeric composition. The composition can include any of the components described herein, including a fluorinated polymer and one or more high aspect-ratio fillers in the indicated amounts. The fluorinated polymer can be included in the mixture in an amount ranging from about 50% to about 95% based on the weight of the mixture. For example, the fluorinated polymer can be present in the molten fluorinated polymer or fluorinated polymer mixture in an amount of about 50%, about 55%, about 60%, about 65%, about 70%, about 75%, about 80%, about 85%, about 90%, or about 95%, based on the weight of the fluorinated polymer mixture. The filler and optionally any suitable additives mentioned above can be included in their indicated amounts.

The liquid fluorinated polymer composition also includes a solvent or a mixture of solvents. Suitable solvents for use in the method include, for example, organic solvents such as aliphatic hydrocarbons, aromatic hydrocarbons, amines, esters, ethers, ketones, and nitrated or chlorinated hydrocarbons. In some examples, the solvent for use in the method can include acetone, ethanol, methanol, isopropanol, 1-butanol, 2-butanol, 2-butanone, 1-propanol, 2-propanol, t-butyl alcohol, carbon tetrachloride, chlorobenzene, chloroform, methyl ethyl ketone, ethyl acetate, toluene, xylene (o-xylene, m-xylene, p-xylene), hexanes, benzene, diethyl ether, cyclohexane, cyclohexanone, dimethylformamide, tetrahydrofuran, acetonitrile, dimethylacetamide, dimethyl sulfoxide, acetamide, 1,2-dichloroethane, diglyme (diethylene glycol dimethyl ether), 1,2-dimethoxyethane, 1,4-dioxane, glycols (e.g., ethylene glycol), glycerin, heptane, hexamethylphosphoramide, hexamethylphosphorus triamide, methyl t-butyl ether, methylene chloride, N-methyl-2-pyrrolidinone, nitromethane, pentane, petroleum ether, pyridine, triethylamine, acetic acid, and the like. In some examples, the solvent(s) can be present in the solution in an amount of at least about 5 vol. %, at least about 10 vol. %, at least about 15 vol. %, at least about 20 vol. %, at least about 25 vol. %, at least about 30 vol. %, at least about 35 vol. %, at least about 40 vol. %, at least about 45 vol. %, at least about 50 vol. %, at least about 55 vol. %, at least about 60 vol. %, at least about 65 vol. %, at least about 70 vol. %, at least about 75 vol. %, at least about 80 vol. %, at least about 85 vol. %, at least about 90 vol. %, or at least about 95 vol. % based on the volume of the liquid fluorinated elastomeric composition.

The liquid fluorinated polymer composition can further include a crosslinker. The crosslinker can be reactive upon application of, for example, a peroxide or heat. In some cases, the crosslinker can be a cyanurate or an isocyanurate such as, for example, triallyl cyanurate, triallyl isocyanurate, trimethylallyl cyanurate, trimethylallyl isocyanurate, trihexenyl cyanurate, trihexenyl isocyanurate, triallylphenyl cyanurate, and triallylphenyl isocyanurate. Optionally, the crosslinker is a triazine compound. A commercially available crosslinker that is suitable with the methods described herein includes VITON VC-7 (Chempoint; Bellevue, WA).

The liquid fluorinated polymer composition can optionally include any of the additional additives described herein. The selection of the additional additives can be made by one of skill in the art based on the desirable characteristics and functions of the product incorporating the elastomeric material described herein. For example, foaming agents or blowing agents can be incorporated into the liquid fluorinated polymer composition when conductive composites with increased porosity and/or lower hardness are desired. In some cases, the porosity of the conductive composites incorporating foaming agents or blowing agents can be at least 20%, at least 30%, at least 40%, at least 50%, at least 60%, at least 70%, or at least 80% higher than a composite without a foaming agent or blowing agent. In some cases, the hardness of the conductive composites incorporating foaming agents or blowing agents can be at least 20%, at least 30%, at least 40%, at least 50%, at least 60%, at least 70%, or at least 80% lower than a composite without a foaming agent or blowing agent.

The conductive fluorinated elastomeric material can be made by mixing the fluorinated polymeric matrix and one or more high aspect-ratio fillers in the presence of one or more crosslinkers and one or more solvents. The mixing can be performed by solvent-assisted compounding, using any suitable apparatus for the selected components, along with the selected amounts (e.g., laboratory-scale or process-scale). In some examples, the mixing can be performed using speed-mixing, internal mixing, ball milling, planetary milling, roll-milling, or an attritor. Optionally, the mixing can be performed using extrusion. Optionally, the mixing can be performed at any suitable temperature, including at room temperature or greater. For example, mixing can be performed at a temperature of from 30° C. to 150° C., from 40° C. to 125° C., or from 50° C. to 100° C.).

After the mixing has been performed, the solvent can be removed. The solvent removal temperature can be determined by one of ordinary skill in the art, based on the choice of solvent for the liquid composition. In some examples, the step of removing the solvent is performed at a temperature of at least 60° C. (e.g., from 60° C. to 100° C., from 70° C. to 90° C., or from 75° C. to 85° C.). The resulting composition can be further processed into a molded product, such as a soft electrode. Notably, the resulting composition is moldable at a temperature from 30° C. to 100° C. The processing can be performed using, for example, compression molding, injection molding or dispensing, three-dimensional processing, freeform fabrication, or direct write extrusion. The molded product can be cured at an elevated temperature, e.g., at a temperature of at least 120° C. (e.g., 130° C. to 200° C., 140° C. to 190° C., 150° C. to 180° C., or 160° C. to 170° C.), for a period of time (e.g., 30 seconds or greater, 1 minute or greater, 10 minutes or greater, 30 minutes or greater, 45 minutes or greater, or 1 hour or greater).

The molded product can have any suitable shape, and can be dictated by the end use of the product. In some cases, the molded product can have a cylindrical shape. Optionally, the cylindrical shape can have a diameter ranging from, for example, 1 mm to 10 mm (3 mm to 7 mm). Optionally, the molded product can be an electrode. The molding process impacts the surface morphology, which impacts its use in electromyography.

In some cases, at least one surface of the molded product can be surface roughened. The surface roughening can be achieved, for example, through any suitable surface roughening method, such as etching (e.g., reactive-ion etching) or grounding (e.g., diamond grounding).

Optionally, the processing can further comprise coating one or more surfaces of the material with a polymer or another material. The coating material can be, for example, poly(3,4-ethylenedioxythiophene) polystyrene sulfonate (PEDOT:PSS), a sulfonated tetrafluoroethylene based fluoropolymer-copolymer, a polymer binder, polyaniline, polypyrrole, silver nanowires (AgNW), gold nanowires (AuNW), liquid metal, or gold. In some cases, the coating can be performed by using dip-coating, ink-jet printing, slot-die coating, screen-printing, aerosol jetting, electrochemical deposition, or a surface treatment using oxygen plasma, a silane treatment, a corona surface treatment, or any other suitable method.

The material can also be cured after the solvent removal step and/or after the processing step. In some cases, the curing can be performed at an elevated temperature (e.g., from 130° C. to 200° C., from 140° C. to 190° C., or from 150° C. to 180° C.) for a period of time. In some cases, the period of time can be up to 5 hours (e.g., from 30 seconds to 5 hours, from 1 minute to 4 hours, from 10 minutes to 3 hours, or from 20 minutes to 2 hours).

Optionally, the molded product exhibits a bulk conductivity of 0.7 Ohm-cm or lower as determined by ASTM D991 (2020). For example, the molded product can have a bulk conductivity of 0.7 Ohm-cm or lower, 0.6 Ohm-cm or lower, 0.5 Ohm-cm or lower, 0.4 Ohm-cm or lower, 0.3 Ohm-cm or lower, 0.2 Ohm-cm or lower, or 0.1 Ohm-cm or lower.

The surface resistance of the elastomeric materials described herein (and the resulting molded product) can be 15 ohm/square or less as determined by ASTM F1529-02 (2017) or ASTM E2884-22 (2022). For example, the molded product can have a surface resistance of 1.5 ohm/square to 15 ohm/square or from 2 ohm/square to 12 ohm/square. In some cases, the surface resistance is 1.5 ohm/square, 2 ohm/square, 2.5 ohm/square, 3 ohm/square, 3.5 ohm/square, 4 ohm/square, 4.5 ohm/square, 5 ohm/square, 5.5 ohm/square, 6 ohm/square, 6.5 ohm/square, 7 ohm/square, 7.5 ohm/square, 8 ohm/square, 8.5 ohm/square, 9 ohm/square, 9.5 ohm/square, 10 ohm/square, 10.5 ohm/square, 11 ohm/square, 11.5 ohm/square, 12 ohm/square, 12.5 ohm/square, 13 ohm/square, 13.5 ohm/square, 14 ohm/square, 14.5 ohm/square, or 15 ohm/square.

The tensile strength of the molded products prepared from the conductive elastomeric materials described herein can be 5 MPa or greater (e.g., 10 MPa or greater) as determined by ASTM D624 (2020). For example, the tensile strength of the molded products can be 5 MPa, 5.5 MPa, 6 MPa, 6.5 MPa, 7 MPa, 7.5 MPa, 8 MPa, 8.5 MPa, 9 MPa, 9.5 MPa, 10 MPa, 10.5 MPa, 11 MPa, 11.5 MPa, 12 MPa, 12.5 MPa, 13 MPa, 13.5 MPa, 14 MPa, 14.5 MPa, 15 MPa, 15.5 MPa, 16 MPa, or 16.5 MPa.

In some cases, the modulus of the molded product is 30 MPa or lower as determined by ASTM D624 (2020). For example, the molded product can have a modulus of 25 MPa or lower, 20 MPa or lower, 15 MPa or lower, 10 MPa or lower, or 5 MPa or lower. In some cases, the modulus is from 0.5 MPa to 30 MPa, 1 MPa to 25 MPa, or 2 MPa to 20 MPa.

The hardness of the molded product can be 95 Shore A or lower as determined by ASTM D2240-15 (2021). For example, the hardness of the molded product can be 90 Shore A or lower, 85 Shore A or lower, 80 Shore A or lower, 75 Shore A or lower, 70 Shore A or lower, 65 Shore A or lower, 60 Shore A or lower, 55 Shore A or lower, 50 Shore A or lower, 45 Shore A or lower, 40 Shore A or lower, 35 Shore A or lower, or 30 Shore A or lower. In some instances, when a molded product of an increased hardness is desired, the hardness of molded product can be from greater than 50 Shore A to 100 Shore A.

The skin contact impedance of the molded product on the skin of a subject (e.g., on the forearm or wrist of a subject) can be 1 MOhms or lower (e.g., 0.9 MOhms or lower, 0.8 MOhms or lower, 0.7 MOhms or lower, 0.6 MOhms or lower, 0.5 MOhms or lower, 0.4 MOhms or lower, 0.3 MOhms or lower, 0.2 MOhms or lower, or 0.1 MOhms or lower) with a geometric contact area of 120 mm². The skin contact impedance can be conducted, for example, on the forearm with a weight positioned on top of the skin (e.g., a 50 g weight) and having an electrode size of 210 mm². An Ag/AgCl wet get electrode can be used as the reference electrode.

The molded products described herein can be integrated into a wearable device. Optionally, the wearable devices can be used to collect biopotential signals or electromyography signals. Suitable wearable devices include, for example, a wristband. Optionally, the molded product can be a monolithic conductive band, in which the elastomer is molded directly into the band rather than incorporating electrodes into the band. Specifically, electrodes are not needed in the monolithic conductive band since the entirety of the band is actively conductive, thus ensuring high surface area for maximal and effective contact. Beneficially, the monolithic conductive band also minimizes noise which may interfere with signal collection.

Throughout this application, various publications are referenced. The disclosures of these publications in their entireties are hereby incorporated by reference into this application.

The examples below are intended to further illustrate certain aspects of the methods and compositions described herein, and are not intended to limit the scope of the claims.

### EXAMPLES

### Example 1: Fabricated Conductive Fluoroelastomers

Conductive fluoroelastomers were fabricated by loading a fluoroelastomer with 1D carbon nanotubes and/or carbon nanofibers. The fluoroelastomer sample, Sample 1, was prepared by loading a fluoroelastomer (VITON GBL-200; Chemours, Wilmington, DE) or Solvay Tecnoflon) with 5 wt. % of aligned multi-walled carbon nanotubes (MWCNTs) having a diameter ranging from 8 to 15 nm. The loading was achieved using solvent-assisted compounding, with molding performed at a temperature of greater than 70° C. The material was cured at a temperature ranging from 140-170° C. for 20-60 minutes. A silicone elastomer was prepared as a comparative example (“Comparative Example”) by loading a silicone elastomer with 5 wt. % aligned MWCNTs and 10 wt. % of carbon nanofibers (CNF) having a diameter of 150 nm, followed by curing at room temperature (˜30° C.) overnight.

The mechanical properties of the resulting loaded elastomers were measured, including the bulk conductivity, hardness, tensile strength, and elongation at break. The tensile strength was measured both before and after curing. The feel to touch was also assessed to determine whether the elastomer felt non-tacky (rating 1), slightly tacky (rating 2), or tacky (rating 3). The electrode-skin impedance measurements were also taken at the forearm and the wrist and compared to gold pogo pins. See Table 1.

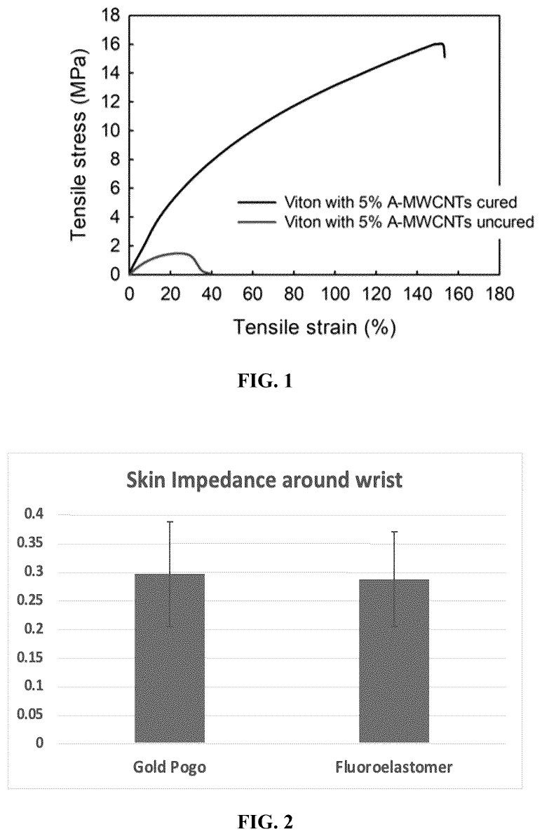

As shown in Table 1, fluoroelastomers can be successfully loaded with conductive 1D fillers to achieve desired properties as dictated by the intended use for the elastomer. In addition, the conductive fluoroelastomer material exhibits increased toughness with reduced skin impedance as compared to the conductive silicone material. The tensile strength of Sample 1 increased substantially after curing, as shown in FIG. 1.

TABLE 1

| | Comparative Sample | Sample 1 |
|---|---|---|
| Elastomer | Silicone | Fluoroelastomer |
| Conductive 1D Fillers | 5 wt. % aligned | 5 wt. % aligned |
| | MWCNT; 10 wt. % | MWCNT |
| | CNF | |
| Process condition | Room temperature | Solvent-assisted |
| | curing overnight | compounding; >70° C. |
| | | for molding; 140-170° |
| | | C. for curing (20-60 |
| | | min) |
| Bulk Volume | 0.90 | 0.45 |
| Resistivity (Ohm-cm) | | |
| Hardness (Shore A) | 43 | 80 |
| Tensile Strength (MPa) | 2.47 | >15 |
| Young's Modulus (MPa) | 4.1 | 25 |
| Elongation at Break (%) | 163 | >150 |
| Feel to Touch | Rating 2 | Rating 1 |

### Example 2: Electrical Performance (System Level)

Skin-electrode impedance of biopotential electrodes made from the conductive fluoroelastomer described in Example 1, with the cylindrical shape of 6.5 mm in diameter and 7 mm in height, were tested using electrochemical impedance spectroscopy. Briefly, three subjects were fitted with a biopotential wristband to which the soft biopotential electrodes were attached. The biopotential electrodes were positioned at 16 different wrist locations and data were collected on four different days (over the course of a 20 day-period). Biopotential signals were also collected by using gold coated brass electrodes in a wristband. The average skin impedance on the subjects' wrist, for both the gold and the soft electrodes, is shown in FIG. 2 and Table 2.

TABLE 2

| | Gold | Fluoroelastomer |
|---|---|---|
| Total Data Points | 32 | 32 |
| Average Skin-Impedance at | 0.296 | 0.287 |
| 30 min (MOhm) | | |

As shown in Table 2 and in FIG. 2, the skin impedance on the wrist was approximately the same for the fluoroelastomer electrodes and the gold electrodes, as the difference as evaluated by the Z score was not statistically significant. Specifically, the Z score of the soft electrode to the Z score of the gold electrode was approximately 0.97 to 1.

### Example 3: Electrical Performance (Component Level)

Skin-electrode impedance of the biopotential electrodes made from the conductive elastomers described in Example 1, with the cylindrical shape of 6.5 mm in diameter and 7 mm in height, were tested using electrochemical impedance spectroscopy. For comparative purposes, commercially available gold pins, which is c360 brass plated with gold (TakeWing, TP015-0101R0A92) were tested. The biopotential electrodes were positioned on the forearm of a subject, and biopotential signals were collected using an electrode-skin impedance system. Data were collected from two subjects.

The average skin impedance on the subject's forearm for the tested electrodes is shown in Table 3.

TABLE 3

| | | Skin Impedance | | |
|---|---|---|---|---|
| | | of Fluoro- | Skin Impedance | Ratio of |
| | | elastomer | of Gold Pin | Fluoro- |
| | Hardness | Electrode | Electrodes | elastomer/ |
| | (Shore A) | (MOhm) | (MOhm) | Gold |
| Subject 1 | 80 | 0.386 | 0.261 | 1.47 |
| Subject 2 | 80 | 0.203 | 0.198 | 1.02 |

As shown in Table 3, the skin-electrode contact impedance of the fluoroelastomer electrode was desirably lower than the skin-electrode contact impedance of the gold pin electrodes.

### Example 4: Bulk Mechanical/Electrical Properties

The effects of different filler contents on conductivity and hardness were investigated by using a 2-factor central composite design. Varying amounts of carbon nanotubes (from 0% to 8%) and carbon nanofibers (from 0% to 15%) were combined and used as fillers in fluoroelastomer composites. The tested carbon nanotubes are aligned multi-walled carbon nanotubes (A-MWCNTs) and the tested carbon nanofibers are carbon nanofibers 19-LHT (CNFs-19-LHT), commercially available from Applied Sciences (Grass Valley, CA). The surface resistance (measured by KLA 4PP) and hardness (Shore A) were assessed for each composite to determine the conductivity and hardness, respectively, and the data are shown in Table 4.

TABLE 4

| | | | Surface | |
|---|---|---|---|---|
| | A-MWCNTs | CNFs-19-LHT | Resistance | Hardness |
| Example | (wt. %) | (wt. %) | (ohm/square) | (Shore A) |
| 1 | 0 | 0 | 1000.00* | 41 |
| 2 | 8 | 0 | 10.16 ± 1.94 | 84 |
| 3 | 0 | 15 | 37.09 ± 3.22 | 77 |
| 4 | 8 | 15 | 5.58 ± 0.88 | 89 |
| 5 | 4 | 7.5 | 2.07 ± 0.17 | 93 |
| 6 | 4 | 7.5 | 2.61 ± 0.15 | 90 |
| 7 | 4 | 7.5 | 1.98 ± 0.06 | 94 |
| 8 | 0 | 7.5 | 145.84 ± 25.47 | 76 |
| 9 | 8 | 7.5 | 7.58 ± 0.38 | 89 |
| 10 | 4 | 0 | 14.16 ± 1.51 | 77 |
| 11 | 4 | 15 | 10.53 ± 2.82 | 86 |
| 12 | 4 | 7.5 | 2.59 ± 0.32 | 92 |
| 13 | 4 | 7.5 | 2.35 ± 0.33 | 93 |
| 14 | 4 | 7.5 | 2.92 ± 0.20 | 89 |

*In Table 4, the resistance of Example 1 is defined as 1000 ohm/square; however, the resistance was defined in this manner for plotting purposes only. No conductivity was detected from Example 1.

The filler combinations resulted in desirable surface resistance and hardness properties. Surface resistances of as low as approximately 2 ohm/square were achieved. In addition, the hardness of the composites increased from 20 Shore A, for the unfilled resin, to up to 90 Shore A for cured composites filled with carbon nanotubes and carbon nanofibers. Notably, synergy was achieved by combining the carbon nanofibers and carbon nanotubes as fillers in the composites. In particular, synergistic mixtures of the carbon nanofibers and carbon nanotubes resulted in composites having desirable surface resistance properties while retaining hardness.

### EXEMPLARY EMBODIMENTS

1. A conductive fluorinated elastomeric material, comprising:
a fluorinated polymeric matrix; and
one or more high aspect-ratio fillers,
wherein a surface resistance of the elastomeric material is 15 ohm/square or less and/or a bulk conductivity of the elastomeric material is 0.7 Ohm-cm or less.
   2. The conductive fluorinated elastomeric material of embodiment 1, wherein the fluorinated polymeric matrix comprises a fluoroelastomer.
   3. The conductive fluorinated elastomeric material of embodiment 2, wherein the fluoroelastomer comprises an FKM rubber.
   4. The conductive fluorinated elastomeric material of embodiment 1, wherein the fluorinated polymeric matrix comprises a fluorosilicone.
   5. The conductive fluorinated elastomeric material of any one of embodiments 1-4, wherein the one or more high aspect-ratio fillers comprises a 1D filler, a 2D filler, or a combination thereof.
   6. The conductive fluorinated elastomeric material of any one of embodiments 1-5, wherein the one or more high aspect-ratio fillers comprises an inorganic filler.
   7. The conductive fluorinated elastomeric material of any one of embodiments 1-6, wherein the one or more high aspect-ratio fillers comprises a conductive filler.
   8. The conductive fluorinated elastomeric material of embodiment 7, wherein the conductive filler comprises a carbon-based filler.
   9. The conductive fluorinated elastomeric material of embodiment 8, wherein the carbon-based filler comprises carbon nanotubes, carbon nanofibers, or combinations thereof.
   10. The conductive fluorinated elastomeric material of embodiment 8 or 9, wherein a surface of the carbon-based filler is functionalized.
   11. The conductive fluorinated elastomeric material of embodiment 10, wherein the surface of the carbon-based filler is functionalized with a hydroxyl group, a carboxylic group, a thiol group, or an amino group.
   12. The conductive fluorinated elastomeric material of any one of embodiments 8-11, wherein the carbon-based filler comprises carbon nanotubes having a diameter from 1 nm to 100 nm.
   13. The conductive fluorinated elastomeric material of embodiment 12, wherein the carbon-based filler comprises carbon nanotubes having a diameter from 2 nm to 90 nm.
   14. The conductive fluorinated elastomeric material of embodiment 12 or 13, wherein the carbon-based filler comprises carbon nanotubes having a diameter from 5 nm to 50 nm.
   15. The conductive fluorinated elastomeric material of any one of embodiments 12-14, wherein the carbon-based filler comprises carbon nanotubes having a diameter from 8 nm to 15 nm.
   16. The conductive fluorinated elastomeric material of any one of embodiments 12-15, wherein the carbon-based filler comprises carbon nanofibers having a diameter from 100 nm to 1000 nm.
   17. The conductive fluorinated elastomeric material of embodiment 16, wherein the carbon-based filler comprises carbon nanofibers having a diameter from 100 nm to 500 nm.
   18. The conductive fluorinated elastomeric material of embodiment 16 or 17, wherein the carbon-based filler comprises carbon nanofibers having a diameter from 130 nm to 200 nm.
   19. The conductive fluorinated elastomeric material of any one of embodiments 9-18, wherein the carbon-based filler comprises a combination of carbon nanotubes and carbon nanofibers.
   20. The conductive fluorinated elastomeric material of embodiment 19, wherein a weight ratio of the carbon nanotubes to the carbon nanofibers is from 1:0.2 to 1:3.
   21. The conductive fluorinated elastomeric material of embodiment 20, wherein the weight ratio of the carbon nanotubes to the carbon nanofibers is from 1:0.5 to 1:2.5.
   22. The conductive fluorinated elastomeric material of embodiment 20 or 21, wherein the weight ratio of the carbon nanotubes to the carbon nanofibers is from 1:1 to 1:2.
   23. The conductive fluorinated elastomeric material of any one of embodiments 1-22, wherein the high-aspect ratio filler is present in an amount of 0.5 wt. % to 30 wt. % based on the weight of the conductive fluorinated elastomeric material.
   24. The conductive fluorinated elastomeric material of embodiment 23, wherein the high-aspect ratio filler is present in an amount of 2 wt. % to 15 wt. % based on the weight of the conductive fluorinated elastomeric material.
   25. The conductive fluorinated elastomeric material of any one of embodiments 1-24, further comprising one or more additional additives.
   26. The conductive fluorinated elastomeric material of embodiment 25, wherein the one or more additional additives is selected from the group consisting of foaming agents, blowing agents, dispersants, plasticizers, surfactants, thixotropic agents, and diluents.
   27. A liquid fluorinated elastomeric composition, comprising:
a fluorinated polymer;
one or more high aspect-ratio fillers in an amount of 0.5 wt. % to 30 wt. %; and
a solvent,
wherein the composition is moldable at a temperature from 30° C. to 100° C.
   28. The liquid fluorinated elastomeric composition of embodiment 27, further comprising a crosslinker.
   29. The liquid fluorinated elastomeric composition of embodiment 28, wherein the crosslinker comprises a peroxide-activated crosslinker or a heat-activated crosslinker.
   30. The liquid fluorinated elastomeric composition of embodiment 28, wherein the crosslinker comprises a triazine.
   31. The liquid fluorinated elastomeric composition of embodiment 28, wherein the crosslinker comprises a cyanurate or an isocyanurate.
   32. The liquid fluorinated elastomeric composition of embodiment 31, wherein the crosslinker is selected from the group consisting of triallyl cyanurate, triallyl isocyanurate, trimethylallyl cyanurate, trimethylallyl isocyanurate, trihexenyl cyanurate, trihexenyl isocyanurate, triallylphenyl cyanurate, and triallylphenyl isocyanurate.
   33. The liquid fluorinated elastomeric composition of any of embodiments 27-32, further comprising a foaming agent or a blowing agent.
   34. A method of making a conductive fluorinated elastomeric material, comprising:
mixing a fluorinated polymeric matrix and one or more high aspect-ratio fillers in the presence of a crosslinker and a solvent to form a composite,
wherein the mixing is performed using solvent-assisted compounding.
   35. The method of embodiment 34, wherein the solvent comprises an organic solvent.
   36. The method of embodiment 34 or 35, further comprising removing the solvent.
   37. The method of embodiment 36, wherein the step of removing the solvent is performed at a temperature of at least 60° C.
   38. The method of any one of embodiments 34-37, further comprising molding the composite at a temperature from 30° C. to 100° C.
   39. The method of any one of embodiments 34-38, further comprising curing the composite.
   40. The method of embodiment 39, wherein the step of curing the composite is performed at a temperature of 130° C. to 200° C.
   41. The method of embodiment 39 or 40, wherein the step of curing the composite is performed for a period of from 30 seconds to 5 hours.
   42. A molded product, comprising a conductive fluorinated elastomeric material according to any one of embodiments 1-26.
   43. The molded product of embodiment 42, wherein the molded product comprises an electrode.
   44. The molded product of embodiment 42 or 43, wherein the hardness of the molded product is 95 Shore A or lower.
   45. The molded product of any one of embodiments 42-44, wherein the surface resistance of the molded product is from 1.5 ohm/square to 15 ohm/square.
   46. The molded product of embodiment 45, wherein the surface resistance of the molded product is from 2 ohm/square to 12 ohm/square.
   47. The molded product of any one of embodiments 42-46, wherein the bulk conductivity of the molded product is 0.7 Ohm-cm or less.
   48. The molded product of embodiment 47, wherein the bulk conductivity of the molded product is 0.5 Ohm-cm or less.
   49. The molded product of any one of embodiments 42-48, wherein the tensile strength of the molded product is 5 MPa or greater.
   50. The molded product of any one of embodiments 42-49, wherein the modulus of the molded product is 30 MPa or lower.
   51. The molded product of any one of embodiments 42-50, wherein the skin contact impedance of the molded product on the skin of a subject is 1 MOhms or lower.
   52. A wearable device, comprising a molded product of any one of embodiments 42-51 integrated into the device.
   53. The wearable device of embodiment 52, wherein the wearable device is a wristband.
   54. The wearable device of embodiment 52, wherein the wearable decide is a monolithic conductive band.
   55. The wearable device of any one of embodiments 52-54, wherein the wearable device collects biopotential signals.
   56. The wearable device of any one of embodiments 52-55, wherein the wearable device collects electromyography signals.

The compositions and methods of the appended claims are not limited in scope by the specific compositions and methods described herein, which are intended as illustrations of a few aspects of the claims and any compositions and methods that are functionally equivalent are within the scope of this disclosure. Various modifications of the compositions and methods in addition to those shown and described herein are intended to fall within the scope of the appended claims. Further, while only certain representative compositions, methods, and aspects of these compositions and methods are specifically described, other compositions and methods are intended to fall within the scope of the appended claims. Thus, a combination of steps, elements, components, or constituents can be explicitly mentioned herein; however, all other combinations of steps, elements, components, and constituents are included, even though not explicitly stated.

What is claimed is:

1. A conductive fluorinated elastomeric material, comprising:
a fluorinated polymeric matrix; and
one or more high aspect-ratio fillers,
wherein a surface resistance of the conductive fluorinated elastomeric material is 15 ohm/square or less and/or a bulk conductivity of the conductive fluorinated elastomeric material is 0.7 Ohm-cm or less.

2. The conductive fluorinated elastomeric material of claim 1, wherein the fluorinated polymeric matrix comprises a fluoroelastomer or a fluorosilicone.

3. The conductive fluorinated elastomeric material of claim 1, wherein the one or more high aspect-ratio fillers comprises a conductive filler.

4. The conductive fluorinated elastomeric material of claim 3, wherein the conductive filler comprises a carbon-based filler.

5. The conductive fluorinated elastomeric material of claim 4, wherein the carbon-based filler comprises carbon nanotubes, carbon nanofibers, or combinations thereof.

6. The conductive fluorinated elastomeric material of claim 4, wherein a surface of the carbon-based filler is functionalized with a hydroxyl group, a carboxylic group, a thiol group, or an amino group.

7. The conductive fluorinated elastomeric material of claim 4, wherein the carbon-based filler comprises carbon nanotubes having a diameter from 1 nm to 100 nm.

8. The conductive fluorinated elastomeric material of claim 4, wherein the carbon-based filler comprises carbon nanofibers having a diameter from 100 nm to 1000 nm.

9. The conductive fluorinated elastomeric material of claim 4, wherein the carbon-based filler comprises a combination of carbon nanotubes and carbon nanofibers.

10. The conductive fluorinated elastomeric material of claim 9, wherein a weight ratio of the carbon nanotubes to the carbon nanofibers is from 1:0.2 to 1:3.

11. The conductive fluorinated elastomeric material of claim 1, wherein the one or more high aspect-ratio fillers is present in an amount of 0.5 wt. % to 30 wt. % based on the weight of the conductive fluorinated elastomeric material.

12. The conductive fluorinated elastomeric material of claim 1, further comprising one or more additional additives selected from the group consisting of foaming agents, blowing agents, dispersants, plasticizers, surfactants, thixotropic agents, and diluents.

13. A liquid fluorinated elastomeric composition, comprising:
a fluorinated polymer;
one or more high aspect-ratio fillers in an amount of 0.5 wt. % to 30 wt. %; and
a solvent,
wherein the liquid fluorinated elastomeric composition is moldable at a temperature from 30° C. to 100° C.

14. The liquid fluorinated elastomeric composition of claim 13, further comprising a crosslinker.

15. The liquid fluorinated elastomeric composition of claim 14, wherein the crosslinker comprises a peroxide-activated crosslinker or a heat-activated crosslinker.

16. The liquid fluorinated elastomeric composition of claim 13, further comprising a foaming agent or a blowing agent.

17. A method of making a conductive fluorinated elastomeric material, comprising:
mixing a fluorinated polymeric matrix and one or more high aspect-ratio fillers in the presence of a crosslinker and a solvent to form a composite,
wherein the mixing is performed using solvent-assisted compounding.

18. The method of claim 17, further comprising molding the composite at a temperature from 30° C. to 100° C.

19. A molded product, comprising a conductive fluorinated elastomeric material according to claim 1.

20. A wearable device, comprising a molded product of claim 19 integrated into the wearable device.
